(19) United States
(12) Patent Application Publication
(10) Pub. No.: US 2003/0171958 A1
(43) Pub. Date: Sep. 11, 2003

(54) Insurance management system, insurance management method and program

(75) Inventor: Isao Funaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/300,595

(22) Filed: Nov. 21, 2002

(30) Foreign Application Priority Data
Mar. 8, 2002 (JP) 2002-63106

(51) Int. Cl. G06F 17/60

(52) U.S. Cl. 705/4

(57) ABSTRACT

An insurance management system for managing an insurance claim for a damage caused by a fault related to information provided in a way of being charged a fee, includes a purchase recording module recording purchase information on a purchase of information provided charged the fee, an insurance registering module registering an insurance contract on the information, an accepting module accepting a notification of a fault related to the information, and a claim indication module indicating an insurance claim for a damage caused by the fault.

### BACKGROUND OF THE INVENTION

The present invention relates to a technology of managing an insurance for a priced content and for encryption key information of the priced content.

The priced content of which a confidentiality is safeguarded or decryption key information for decrypting encrypted data of the priced content might not be copied and backed up in terms of safeguarding the content in some cases.

For instance, a backup file of call melody data stored on a mobile phone can not be created. Therefore, if the mobile phone itself falls into a fault and is exchanged with a new one, the user needs to repurchase the call melody data.

Similarly, data of a content such as image data downloaded into the mobile phone and an application program running on the mobile phone might not be, if the device (mobile phone) is exchanged, transferred to a new device from the old device as the case may be.

Further, the problems given above might also arise with respect to a server and a personal computer put on the market in a way that preinstalls an operating system (OS) and various categories of application programs into a built-in hard disk.

Namely, under a condition that does not provide an environment for actualizing the installation utilizing a network and a recording medium for installing the OS and the application programs, the built-in hard disk might fall into a fault, and neither the OS nor the application programs function normally in some cases.

In this case also, the user has to repurchase the OS and the application programs.

Further, the makers sell portable players for reproducing the contents such as music, pictures etc stored on a flash memory card and so on. The contents stored on this type of flash memory card are likewise encrypted in terms of safeguarding the copyrights in the great majority of cases. Those encrypted contents can not, if once copied onto other mediums, be decrypted in many cases. Accordingly, the same problem as the above-mentioned occurs also if the flash memory card is damaged.

### SUMMARY OF THE INVENTION

Thus, even for a backup purpose, it is not permitted in many cases that a priced content is copied or decryption key information for decrypting the encrypted data of the priced content is copied in order to protect the priced content from an unauthorized copy thereof. Under such a circumstance, a purchaser's right for the priced content purchased is not safeguarded, and, if a large quantity of these priced contents are stored on a large-capacity storage device (terminal), there is a possibility of suffering from tremendous damages. Another possibility is that if an amount of damage to the storage device of the user is large, a compensation for the damage might be claimed against the maker that manufactured and sold this storage DEVICE.

It is a primary object of the present invention, which was devised in view of the problems inherent in the prior arts described above, to provide a technology for supporting, if a fault occurs in copy-inhibited information or information stored on a storage device or medium of which no copying module is available or if the fault occurs in the medium or the storage device, a compensation for a loss on the side of a purchaser of the information described above.

To accomplish the above object, according to one aspect of the present invention, an insurance management system for managing an insurance claim for a damage caused by a fault related to information provided in a way of being charged a fee, includes a purchase recording module recording purchase data on a purchase of information provided in a way of being charged a fee, an insurance registering module registering an insurance contract on the information, an accepting module accepting a notification of a fault related to the information, and a claim indication module indicating an insurance claim for a damage caused by the fault.

Herein, the information is, for example, the priced content, decryption key information for decrypting the priced content and so on. Further, this category of information may include priced information and, in addition, information provided by a priced service. This type of service may be, for example, a service that permits the user to download a content limitlessly or under a predetermined limit from on a download site at a monthly fixed fee, or a service that permits the user to download a predetermined number of contents (e.g., two sets of contents at the maximum and so on) from on the download site at a predetermined fee, and so forth. According to the present invention, the information described above may include pieces of information obtainable through the services given above.

The present invention supports a payment of insurance money for a damage caused by a fault related to the information described above. Herein, the fault related to the information implies that the content can not be utilized due to the fault in the medium, the device(terminal) etc that are stored with the content. The fault may include a fault in the content itself and, in addition, a fault in the device stored with the content. Further, this category of information may include such a case that the content can not be decrypted due to the fault in the device etc that retains the key information for decrypting the content.

Moreover, the insurance registering module registers details of an insurance contract with respect to the information described above. The insurance registering module may, however, be a module requesting a system of an insurance company to register the insurance contract instead of registering the details of the insurance contract in the present insurance management system.

In this case, the present insurance management system is, it may be sufficient, capable of recognizing that the above information is defined as an object of the insurance contract, and the details of the insurance contract may be managed by the system of the insurance company. If all pieces of information containing a record of the purchase information become an object of the insurance contract, however, the object of the insurance contract can be recognized from items recorded in the purchase recording module.

According to the present invention, the insurance contract about the information described above is registered beforehand. Then, the insurance management system according to the present invention is, when the fault related to the information described above occurs, notified of this fault, and gives an indication of the insurance claim for the damage thereof. A notice of this indication may be sent to, e.g., a person in charge of the insurance claim or to a payer of insurance money.

Preferably, the insurance management system may further include a showing module showing an amount of money for the damage. Herein, the amount of money for the damage is, for instance, a total amount of money for the damage caused by the fault described above, an amount of damage for every fault-related piece of information, or an amount of insurance money for these damages, and so on.

Preferably, the information may be stored on a medium of which no backup creating module is available, and the purchase recording module may record identifying information for identifying the medium or identifying information for identifying a device including the medium.

The medium of which no backup creating module is available is, for example, a mobile phone or a PHS on which a call melody and an awaiting image are stored, a memory card not allowed to copy the data, a computer into which a computer program provided with no installing module is installed, and so on.

Preferably, the accepting module may accept the identifying information of a medium in which a fault occurs or the identifying information of a device in which a fault occurs, and the claim indication module may display a list of information stored on the medium or the device identified by the identifying information.

Any one of the above components according to the present invention may be actualized as a program of a computer.

According to another aspect of the present invention, there is provided a method in which a computer, other kind of device or machine executes any one of the processes described above.

According to still another aspect of the present invention, there is provided a program read by a computer to actualize any one of the functions described above.

According to another aspect of the present invention, there is provided a readable-by-computer recording medium recorded with such a program.

As explained above, according to the present invention, it is possible to support, if the fault occurs in the copy-inhibited information or the information stored on the storage device or the medium of which no copying module is available or if the fault occurs in the medium or the storage device, the compensation for the loss on the side of the purchaser of the information described above.

### BRIEF DESCRIPTION OF THE DRAWINGS

FIG. 1 is a diagram showing a principle of an information system in one embodiment of the present invention;

FIG. 2 is a flowchart showing an outline of processes by the information system;

FIG. 3 is a diagram showing a system architecture of the information system;

FIG. 4 is a diagram showing a structure of a record of a customer information database 31;

FIG. 5 is a diagram showing a structure of a record of a vendor content database 11;

FIG. 6 is a diagram showing a structure of a record of a purchaser DEVICE information database 12;

FIG. 7 is a flowchart showing a payment management process; and

FIG. 8 is a flowchart showing an insurance money payment supporting process.

### DETAILED DESCRIPTION OF THE PREFERRED EMBODIMENT

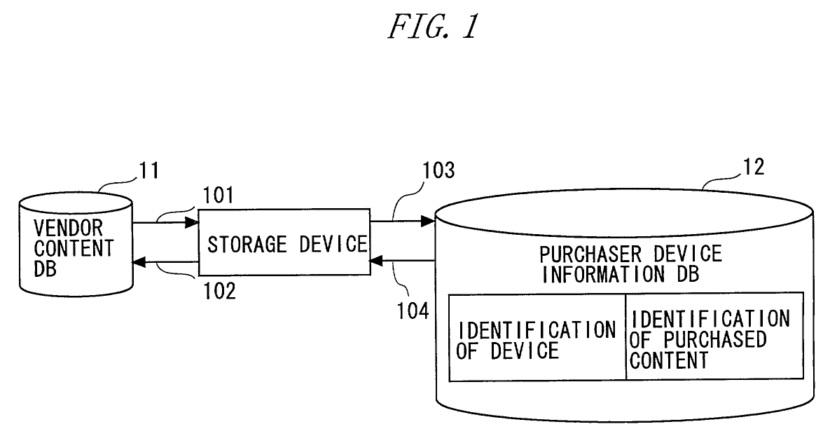

One embodiment of the present invention will hereinafter be described with reference to FIGS. 1 through 8.

<Principle of Information System>

FIG. 1 shows a principle of an information system in this embodiment. The present information system supports a service for compensating for a loss attributed to a fault of a content impossible of being backed up. The fault may include a fault of decryption key information impossible of being backed up (the key information is simply called a key as the case may be) for decrypting encrypted data of the content.

The content impossible of being backed up is a content such as a call melody, an awaiting image etc. of a mobile phone and a PHS (Personal Handyphone System). This category of content includes, for instance, operating systems and a variety of application programs, which are vended in a way that preinstalls these pieces of software into personal computers and built-in hard discs of servers.

Further, the decryption key information is defined as key information used for reproducing the content that has been encrypted and thus stored. In this embodiment, each of the mobile phone and the PHS stored with the contents is termed a storage device.

The present information system, when such a content is purchased and stored in the mobile phone etc, registers the purchased content and the mobile phone etc as a storage location of this content in a database of an insurance system. Then, the present information system, if the mobile phone falls into a fault (or a trouble) such as a failure or being lost or stolen and so on, compensates for an amount of the damage to the content suffering from the damage due to that fault (trouble).

As illustrated in FIG. 1, the present information system includes the storage devices such as the mobile phones etc utilized by users, a vendor content database 11 of a vendor who provides the contents to the storage devices, and a purchaser device information database 12 for managing the contents vended (purchased by the users) to the users.

Herein, the vendor content database 11 is defined as a database stored with the contents that are to be vended to the users and with the decryption key information for decrypting the encrypted contents. Further, the purchaser device information database 12 is stored with pieces of purchase information (information indicating the content itself and information indicating a storage location of the content) when the user purchases the content.

This item of purchase information contains, for instance, identifying information for identifying the mobile phone etc as a storage location of the vended content, identifying information for identifying the vended content, and so forth. Herein, the identifying information for identifying the mobile phone etc may be information such as a name of maker, a type number, a serial number, a telephone number etc of the terminal device (the mobile phone etc), which uniquely identify the storage DEVICE concerned.

The present information system records these pieces of information when the content is vended. Then, if there occurs such a fault (trouble) that the mobile phone etc is damaged, lost or stolen and so on, the information system is notified of the occurrence of this fault and supports the content purchaser for its initial measures to be taken. Then, the information system compensates the content purchaser for the damage by the insurance money. The initial measures are herein confirmation of a validity of this notification (e.g., confirmation of a credibility about the damage to the mobile phone), a recovering measure based on this notification (such as a request for returning the lost or stolen mobile phone, and so on).

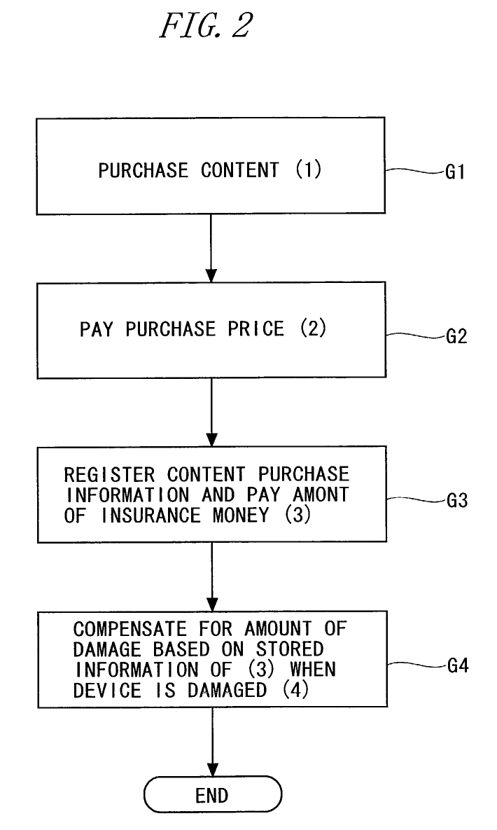

FIG. 2 shows a outline of a processing flow in this information system. To start with, the user purchases a content through the mobile phone etc (G1, as indicated by an arrowhead 101 in FIG. 1). Further, the user pays a purchase price to the vendor (G2, as indicated by an arrowhead 102 in FIG. 1).

In this case, the user further makes requests for registering the content information and taking out an insurance, and pays an insurance fee (G3, as indicated by an arrowhead 103 in FIG. 1). In this state, the content purchased is stored on the mobile phone etc. The user can neither, however, transfer the purchased content to storage devices other than the mobile telephone, nor utilize, even if transferred to other storage devices, this content on these other storage DEVICEs.

A case where the mobile phone etc is damaged after establishing the transaction described above, is considered. In this case, the present information system takes the initial measure in response to a request from the user. This initial measure is, e.g., the confirmation of whether the mobile phone etc falls actually into the fault. Then, the present information system, based on the information registered in the process G3, compensates for an amount of the damage to the content stored in the storage device (G4, as indicated by an arrowhead 104 in FIG. 1).

<System Architecture>

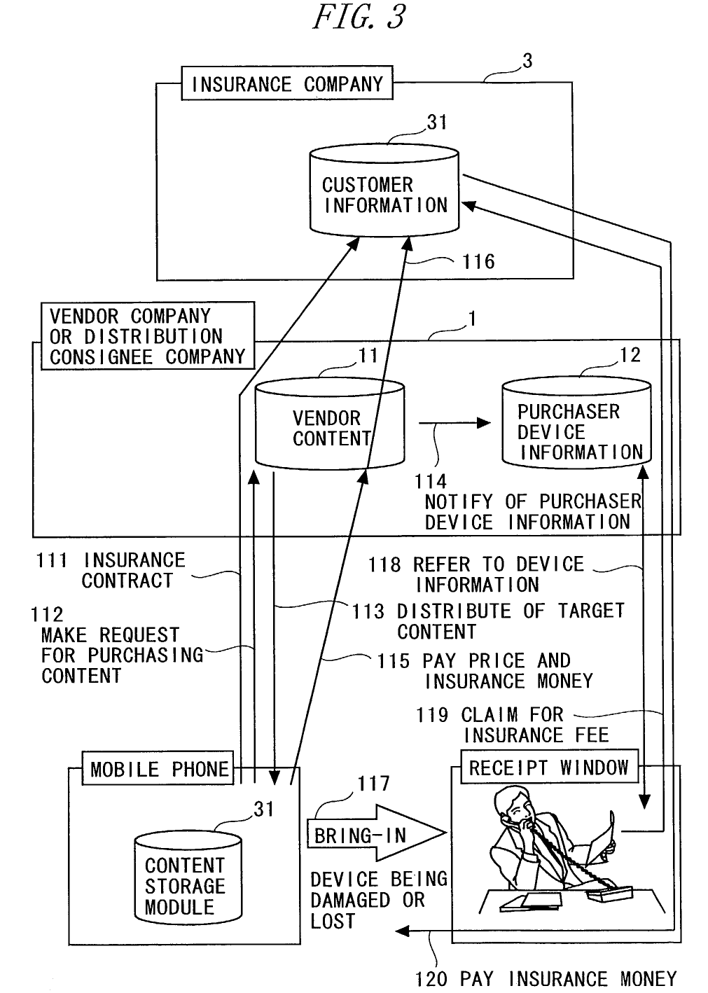

FIG. 3 is a diagram showing a system architecture of the information system in this embodiment. The present information system is configured by a vendor server 1 used by a content vendor or a content distribution consignee company consigned to distribute the content, the mobile phones etc utilized by the users, and an insurance management server 3 used by the insurance company.

The vendor server 1 has the vendor content database 11. The vendor content database 11 is stored with various categories of contents to be vended to the users. Further, the vendor server 1, when the user purchases the content, stores purchaser device information in the purchaser device information database 12. The purchaser device information may be information for identifying the mobile phone etc on which the content is stored, information for identifying the content purchased, and so on.

The vendor server 1 itself may, however, be configured by a plurality of servers linking to each other via a network. For instance, the vendor server 1 may also be a system configured by a database server for managing the vendor content database 11, a database server for managing the purchaser device information database 12, a Web server for providing Web sites, a communication-oriented computer that accesses the insurance management server 3, and so on.

The insurance management server 3 has a customer information database 31, and manages customer information on insurants. The customer information may be information for identifying, for example, an insurance contract number, a name of the customer, and an insured device as an object of the insurance contract.

A flow of transaction in this information system will hereinafter be discussed. According to the present information system, a premise of the system management is that at first an insurance contact on the content be established between the user and the insurance company (as indicated by an arrowhead 111). This procedure is the same as in the case of a conventional indemnity insurance, wherein the contract is made based on insuring the mobile phone etc on which the content is stored. In this case, the customer information database 31 is stored with information (e.g., a manufacturing serial number and a terminal ID given from the telephone company) from which a type of the device as the contract object can be uniquely identified.

After establishing such an insurance contract, the present information system is operated in the following processes. To be specific, the user accesses the vendor server 1 and makes a procedure of purchasing a desired content such as a call melody etc (as indicated by an arrowhead 112) by executing a general process (e.g., selecting the content on the Web page, and so on).

The purchase target content is stored in, e.g., the vendor content database 11 of the vendor server 1. When the user accesses the Web site on the vendor server 1, a list of the contents stored in the vendor content database 11 is displayed on the mobile phone etc of the user. The user selects a desired content and executes the purchase procedure.

As a result of this purchase procedure, the content purchased (vended by the vendor server 1) is distributed to the mobile phone of which the insurance contract was made (an arrowhead 113). In this case, the vendor server 1 records the vended content and a vending target device (the mobile phone etc) in the purchaser device information database 12 (an arrowhead 114).

Next, the user pays a price of the content and an insurance fee (an arrowhead 115). The vendor server 1, after confirming the payment, pays the insurance fee to the insurance management server 3 of the insurance company (an arrowhead 116). A payment from the vendor server 1 to the insurance management server 3 may be made through an unillustrated bank account management server. To be specific, the account management server may pay the insurance fee into an insurance company's own bank account in response to a request from the vendor server 1, and may notify the vendor server 1 and the insurance management server 3 of a result of this payment.

After the insurance contract has thus been concluded, if the device on which the content is stored is damaged or stolen or lost, the user informs a telephone company receipt window of this purport (which corresponds to [bring-in] indicated by an arrowhead 117). In this case, the user shows the insurance contract number, the manufacturing serial number of the contract object device, and so on.

A person in charge of the receipt window inputs the insurance contract number, the manufacturing serial number of the contract object device etc via an unillustrated terminal connected to the vendor server 1, and indicates the vendor server 1 to confirm the contents of the insurance contract. The vendor server 1 refers to the purchaser device information database 12, thus obtaining a list of the contents purchased by this device. Further, the vendor server 1 calculates a total amount of damage on the basis of the list of the contents and the vendor content database 11 (an arrowhead 118). The vendor server 1 displays the list of the contents purchased and the total amount of damage on the terminal at the receipt window, and indicates a claim for the insurance money.

The person in charge of the receipt window, based on the indication from the vendor server 1, specifies the insurance contract number, the total amount of damage etc, and claims the insurance money against the insurance management server 3 of the insurance company (an arrowhead 119). The insurance management server 3 indicates the insurance company to pay the insurance money in accordance with the contents of the contract. As a result, the insurance money is paid to the user from the insurance company (an arrowhead 120).

<Data Structure>

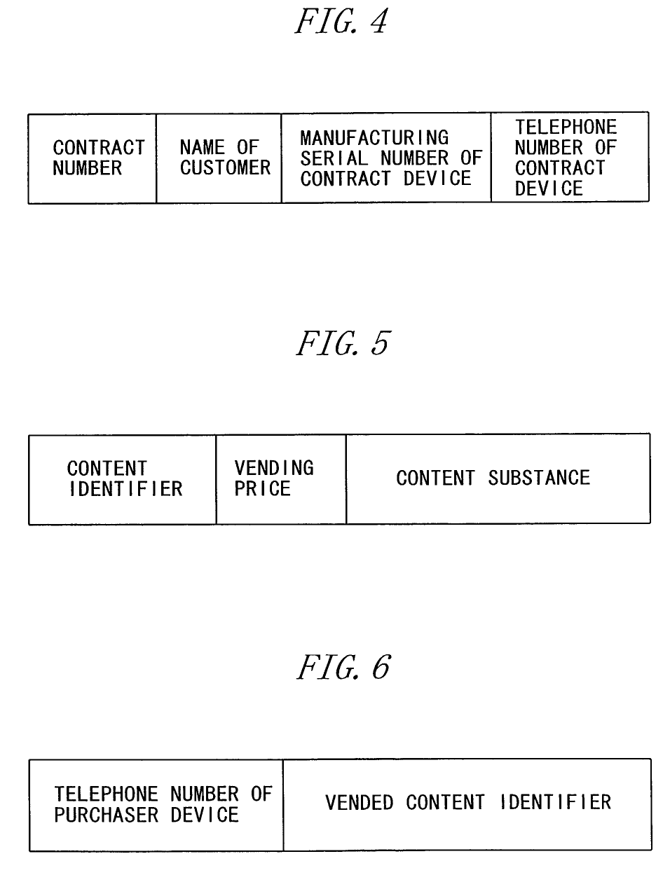

FIG. 4 is a diagram showing a structure of a record of the customer information database 31. Each record of the customer information database 31 consists of data entered in a “contract number” field, a “name of customer” field, a “manufacturing serial number of the contract object device” field and a “telephone number of the contract device” field. The customer information database 31 has a function of managing the insurance contracts on the basis of such items of data.

The contract number is defined as information for uniquely identifying the insurance contract. The name of customer is a character string representing a name of the user who agreed upon the contract. The manufacturing serial number of the contract DEVICE is information for identifying the mobile phone etc as an object of the insurance contract. The telephone number of the contract device is a telephone number of the contract object device such as the mobile phone etc.

FIG. 5 shows a structure of a record of the vendor content database 11. The vendor content database 11 has a “content identifier” field, a “vending price” field and a “content substance” field.

The content identifier is information for identifying the content. Whatever information unique to the content in the vendor server 1 may suffice for the content identifier. For instance, however, pieces of content identifying information defined in the business circle of music etc may also be utilized as they are.

The vending price is a fee charged when the user downloads the content. The content substance is the content itself and is just the substance of each of, e.g., call melody data, an image, an application program executed on the mobile phone and so on.

FIG. 6 is a diagram showing a structure of a record of the purchaser DEVICE information database 12. Each record of the purchaser device information database 12 consists of data entered in a “telephone number of purchaser device” field and a “vended content identifier” field. The telephone number of the purchaser device is a telephone number of the mobile phone etc on which the content is stored as in the case of the telephone number of the contract device shown in FIG. 4. Further, the vended content identifier is the content identifier shown in FIG. 5. The purchaser device information database 12 records such a mapping of the information on the content purchaser device and the information on the vending target content.

<Operation>

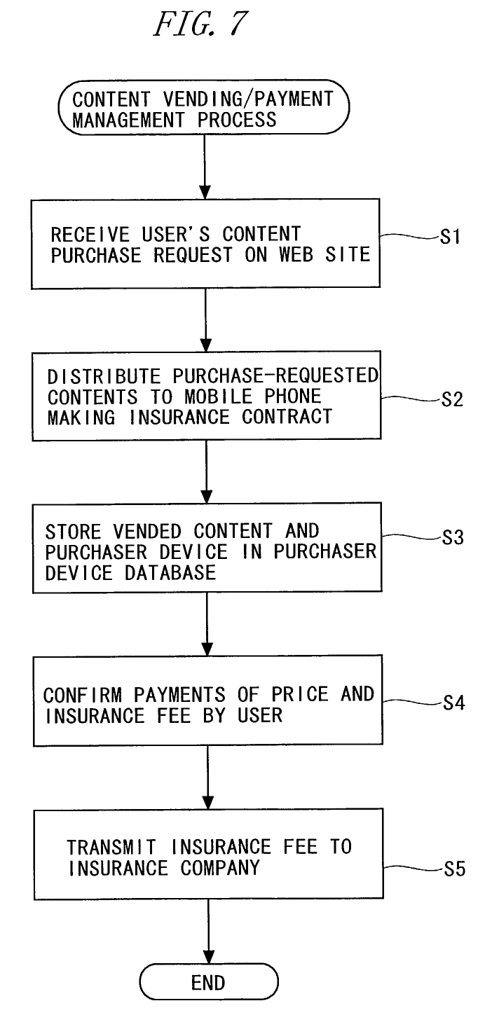

FIG. 7 is a flowchart showing a content vending/money-receiving process executed by the vendor server 1 shown in FIG. 3.

In this process, to start with, the vendor server 1 accepts on the Web site a content purchase request of the user (S1).

Then, the vendor server 1 distributes the purchase-requested content to the mobile phone etc (S2) Subsequently, the vendor server 1 records the content vended and the purchaser device (mobile phone) in the purchaser device information database 12 (S3).

Next, the vendor server 1 confirms a receipt of the price and the insurance fee from the user (S4). Then, the vendor server 1 transmits the insurance fee to the insurance company (S5).

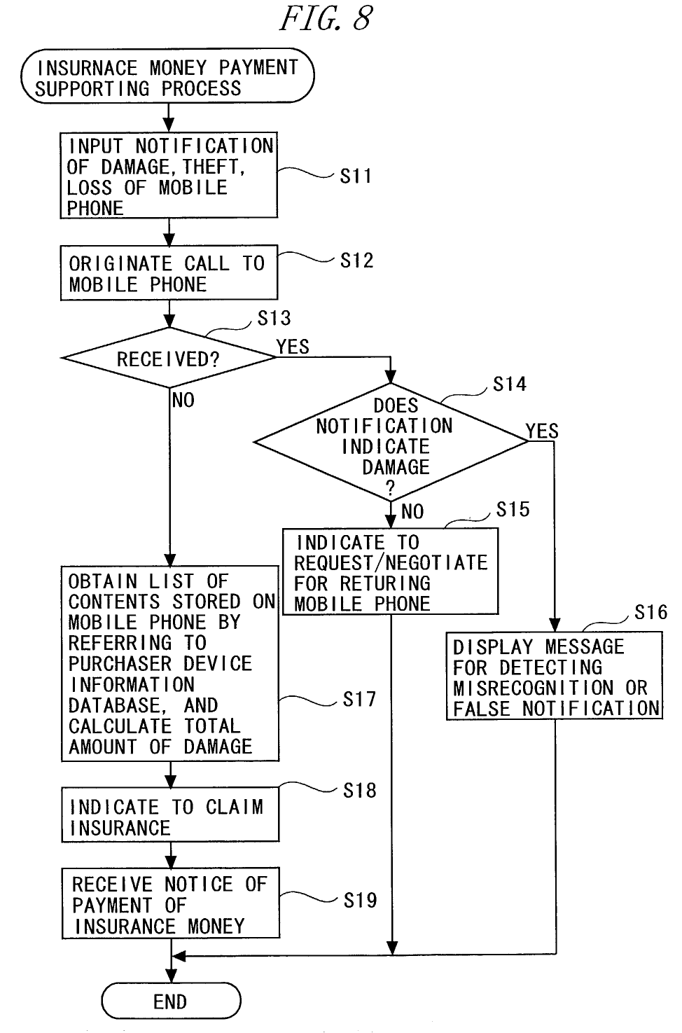

FIG. 8 shows an insurance money payment supporting process. In this process, at first, the vendor server 1 receives inputting a notification that the mobile phone is damaged or stolen or lost from the person in charge of the receipt window in the telephone company (S11). In this case, the vendor server 1 prompts the in-charge person to input the telephone number (the telephone number of the purchaser device shown in FIG. 6) of the mobile phone as an insurance claimant's object.

Then, the vendor server 1 originate a call to the mobile phone of the telephone number (S12) and checks whether the very mobile phone can receive a call originated from the vendor server 1 (S13). When this mobile phone receives the call, the vendor server 1 judges whether the notification given in S1 specifies a damage or not (S14). If not the damage (which implies that the notification indicates a loss, a theft etc), the vendor server 1 indicates the person in charge of the receipt window to negotiate and request the person using the mobile phone to it to the owner (S15).

Further, if the notification indicates the damage, the vendor server 1 displays on the terminal at the receipt window a message saying that the notification is made from a misrecognition or is false (S16). Thereafter, the vendor server 1 finishes processing.

While on the other hand, when judging in S13 that the call is not received by the mobile phone as an object for notification, the vendor server 1 obtains the list of the contents stored on the concerned mobile phone by referring to the purchaser device information database 12, and calculates a total amount of damage (S17). Then, the vendor server 1 displays an indication of claiming the insurance money on the terminal at the receipt window (S18). The person in charge of the receipt window transmits, based on this indication, the claim for the insurance money to the insurance management server 3 of the insurance company.

Next, the vendor server 1 receives a notice of payment of the insurance money and confirms the payment (Sl9). Thereafter, the vendor server 1 finishes processing.

<Effects of the Embodiment>

As discussed above, the present information system supports compensating by insurance for, if occurred, the fault in the content unallowable to be copied and difficult to be copied in terms of the system architecture.

Further, the present information system provides the function of confirming, when notified of the failure or loss or theft of the content storage device, the initial measure, for instance, the credibility of this notification. Owing to this function, the person in charge of the receipt window in, e.g., the telephone company is able to narrow down the notification of the failure or loss or theft into a more precise piece of information before claiming the insurance money against the insurance company.

<Modified Example of Storage DEVICE>

The discussion in the embodiment described above has been focused on the information system that compensates for the damage to the content stored on the mobile phone or the PHS, or the damage to the key information for decrypting the encrypted content. The embodiment of the present invention is not, however, limited to the architecture described above.

For example, a content such as pictures, sounds, music etc is stored on a medium like a flash memory card and so on, and is reproduced by a portable player. In such a medium, the content is normally encrypted and decrypted when reproduced. Some of the contents in this category can not, if once transferred or copied to other mediums, be decrypted any more. What is adopted is, for instance, a protection function of recognizing, on the occasion of decrypting the encrypted content, the information for identifying the medium stored with the content and rejecting, if this piece of identifying information is not valid, the decryption thereof.

The embodiment of the present invention can be applied to general categories of contents on the medium adopting the protection function described above. In this case, a piece of identifying information and a serial number of the medium may be recorded, as a substitute for the purchaser device telephone number shown in FIG. 6, in the purchaser device information database 12.

A credibility of the notification of a failure etc of the medium described above can not be, however, confirmed from whether the call is received by or not as in the case of the mobile phone (and, such being the case, the staff at the receipt window may manually confirm whether it is not actually reproducible).

<Modified Example of Accessing Device>

According to the embodiment discussed above, the user accesses the vendor server 1 through the mobile phone, and may also access the vendor server 1 through a PHS, a personal computer, a PDA (Personal Digital Assistant), an installed-into-car device, a digital TV and so on as a substitute for the mobile phone.

For instance, there may be taken a system in which the user temporarily downloads the content (such as the call melody data and the awaiting image data) to be stored on the mobile phone into the personal computer, and thereafter transfers the content to the storage DEVICE.

In this case, for example, it follows that a backup file is created on the personal computer in terms of a procedure. There is, however, a case where the content is allowed to be decrypted only on a specified storage device (which is uniquely identified by the identifying information) and is, even if transferred to other storage devices, so encrypted as not to be utilized. Even when holding a copy of such an encrypted content, and if the storage device allowed to utilize the content falls into a failure, the content has already become difficult to be utilize. The insurance contact agreed upon in this information system described in the present embodiment is effective in this content.

<Modified Example>

The embodiment discussed above has dealt with the procedure of applying for the insurance that the insurance fee on the content is paid each time the content is purchased. The embodiment of the present invention is not, however, limited to the contract procedure described above.

There may be executed, for instance, such a contract procedure as to pay insurance fees in one lump sum beforehand. In this case, the insurance fee may be set per mobile phone. Further, the insurance fee may be set in a way that sets a predetermined content count or data size as an upper limit.

For example, an insurance fee of 100 yen may be set up to ten pieces of call melody data. Further, an insurance fee of 100 yen may be set for the awaiting image data having up to 1 Mbytes. Another option is that an insurance fee of 500 yen is set for all the contents (sounds, pictures, images) within the mobile phone having a data size of 10 Mbytes at the maximum, and so on.

According to the embodiment discussed above, when the notice of fault of the mobile phone etc is brought in at the receipt window, the vendor server 1 indicates the total amount of damage etc to the person in charge of the receipt window and requests the in-charge person to claim the insurance money against the insurance company. Instead of this, however, the vendor server 1 may directly claim the insurance money against the insurance company (or the insurance management server 3). More specifically, when the fault of the mobile phone as the object for the insurance against the fault is inputted from the person in charge of the receipt window, the vendor server 1 may calculate the total amount of damage and may transmit the claim for the insurance money to the insurance management server 3. A claim-for-insurance-money program for executing the processes described above may be implemented in the vendor server 1.

<<Storage medium readable by a machine>>

A program executed by a machine to actualize any one of the functions described above may be recorded on a storage medium readable by the machine. Then, the machine reads and executes the program on this recording medium, whereby this function can be provided.

Herein, the storage medium readable by a machine embraces recording mediums capable of storing information such as data, programs, etc. electrically, magnetically, optically and mechanically or by chemical action, which can be all read by the machine. What is demountable out of the machine among those recording mediums may be, e.g., a flexible disk, a magneto-optic disk, a CD-ROM, a CD-R/W, a DVD, a DAT, an 8 mm tape, a memory card, etc..

Further, a hard disk, a ROM (Read Only Memory) and so on are classified as fixed type recording mediums within the machine.

<<Data Communication Signal Embodied in Carrier Wave>>

Furthermore, the above program may be stored in the hard disk and the memory of the computer, and downloaded to other machines (computers) via communication media. In this case, the program is transmitted as data communication signals embodied in carrier waves via the communication media. Then, the computer downloaded with this program can provide the function described above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. An insurance management system comprising:
a purchase recording module recording purchase data on a purchase of information provided in a way of being charged a fee;
an insurance registering module registering an insurance contract on the information;
an accepting module accepting a notification of a fault related to the information; and
a claim indication module indicating an insurance claim for a damage caused by the fault.

2. An insurance management system according to claim 1, further comprising a showing module showing an amount of money for the damage.

3. An insurance management system according to claim 2, wherein the information is stored on a medium of which no backup creating module is available, and
said purchase recording module records identifying information for identifying said medium or identifying information for identifying a device including said medium.

4. An insurance management system according to claim 3, wherein said accepting module accepts the identifying information of a medium in which a fault occurs or the identifying information of a device in which a fault occurs, and
said claim indication module displays a list of information stored on said medium or said device identified by the identifying information.

5. An insurance management method comprising:
recording purchase data on a purchase of information provided in a way of being charged a charge;
registering an insurance contract on the information;
accepting a notification of a fault related to the information; and
indicating an insurance claim for a damage caused by the fault.

6. An insurance management method according to claim 5, further comprising showing an amount of money for the damage.

7. An insurance management method according to claim 5, wherein the information is stored on a medium of which no backup creating module is available, and
said purchase data involves identifying information for identifying said medium or identifying information for identifying a device including said medium.

8. An insurance management method according to claim 5, wherein said notification involves the identifying information of a medium in which a fault occurs or the identifying information of a device in which a fault occurs, and
said indicating involves displaying a list of information stored on said medium or said device identified by the identifying information.

9. A storage medium readable by a machine, tangible embodying a program of instructions executable by the machine to perform method steps comprising:
recording purchase data on a purchase of information provided in a way of being charged a fee;
registering an insurance contract on the information;
accepting a notification of a fault related to the information; and
indicating an insurance claim for a damage caused by the fault.

10. A storage medium readable by a machine according to claim 9, wherein said computer is made to further execute showing an amount of money for the damage.

11. A storage medium readable by a machine according to claim 9, wherein the information is stored on a medium of which no backup creating module is available, and
said purchase data involves identifying information for identifying said medium or identifying information for identifying a device including said medium.

12. A storage medium readable by a machine according to claim 9, wherein said notification involves the identifying information of a medium in which a fault occurs or the identifying information of a device in which a fault occurs, and
said indicating involves displaying a list of information stored on said medium or said device identified by the identifying information.
